(19) United States
(12) Patent Application Publication
(10) Pub. No.: US 2013/0039367 A1
(43) Pub. Date: Feb. 14, 2013

(54) Peer-to-Peer Packet Switching

(71) Applicant: Daniel Marian ENE, Montreal (CA)

(72) Inventor: Daniel Marian ENE, Montreal (CA)

(73) Assignee: TELEFONAKTIEBOLAGET L M ERICSSON (PUBL)

(21) Appl. No.: 13/208,845

(22) Filed: Aug. 12, 2011

(51) Int. Cl. H04L 12/56

(52) U.S. Cl. 370/401; 370/389

(57) ABSTRACT

Peer-to-Peer traffic switching that allows gateway traversal is accomplished using a traffic switch that receives packets from each of the nodes, accommodates synchronization flags, as well as sequence numbering and packet acknowledgements. Avoiding a complex and cumbersome registration process allows two peer nodes to communicate with each other while traversing network address translation gateways, and allows for a process that provides a transparent experience to both nodes so that they do not necessarily perceive that they are communicating through a gateway.

### TECHNICAL FIELD

This disclosure relates generally to handling of client data packet switching to allow network traversal.

### BACKGROUND

As the features provided by data networks become more ubiquitous in the lives of many users, the number of devices through which the features and services of these data networks has increased. Historically, content was created centrally and distributed as traffic on the data network as it was delivered to the content consumer. As user created content became more important, the traffic flows were partially reversed as users created content instead of just consuming it. However, user created content is typically sent to a publicly addressable server, and is made available for other nodes to access through the server.

As the features available on data networks grow and improve, there is an increased demand for peer-to-peer communications. At first this demand was related to file transfer, but as time and network and device capabilities have expanded the profile of peer-to-peer traffic has expanded to include audio and video sessions, including both voice-over-Internet Protocol (VoIP) and video-chatting. This increase in demand has occurred in conjunction with an increase in the number of connected devices.

Where previously, connected devices were only intermittently connected, were limited in geographic scope, and were typically end user computers and network infrastructure such as routers, the variety of connected devices has increased to include many mobile devices such as so-called smart-phones, tablets, televisions, and numerous other consumer electronics devices. At the same time, the geographic base of connected devices has expanded from the initial concentration in North America and Western Europe to be far more global in scale. This increase in the number of connected devices has resulted in a shortage in the available address space. Two solutions have arisen to the shortage of address space, the first is the user of Network Address Translation, while the second is a change to IPv6 to increase the available address space.

Network Address Translation is a well known technique that employs a gateway having a public address to provide connectivity to a plurality of different network nodes that are provided with private network addresses. NAT implementations raise a number of problems, because the private network node is not directly connected to the network. Where the private node initiates a connection with a publicly addressable node, a session can be created without too much difficultly. However, when a public nodes wishes to initiate a session, problems can arise unless the NAT has been pre-configured to receive traffic on a particular port that is permanently assigned to a specific node. Due to the difficulties of standardizing such behavior, and the inability of a node to properly publicize the address and port assigned to it, it is difficult for nodes outside of the public network to initiate a session with a node behind a firewall.

An even larger known problem is how two nodes, each of which reside behind separate NAT gateways are able to create a peer-to-peer session. Because each node is in a different private network, neither node can reliably use a public address that allows it to receive the session initialization request.

To address these problems, a number of protocols have been introduced. One such protocol is Session Traversal Utilities for NAT (STUN) which is defined and described in IETF RFC 5389. However, while STUN has utility in allowing traversal of a single NAT, issues arise where both clients are in different private networks and the connection must bridge two NATs. In such a case, a coordinating node is typically employed that allows a first private node to connect, and then provides that node with information associated with the public address that is seen to be associated with the private node. When both nodes in a session are located in private networks, a great deal of co-ordination must occur to allow STUN based connections to be used. This introduces complexity and makes setting up a session difficult. Furthermore, the node that allows co-ordination must have a public address, and cannot itself reside behind a NAT.

Another such open solution is Traversal Using Relay NAT (TURN) which is defined and described in IETF RFC 5766 (an IPv6 update is defined in IETF RFC 6156). TURN is more successful at allowing connectivity between two nodes in separate private networks, but involves a very high overhead that is borne by the TURN server. This reduces the efficacy of TURN in many situations. However, many video chat applications make use of TURN servers due to their ability to traverse NATs. The high overhead and complexity of initiating a session is largely borne by the TURN server. However, some of the complexity and overhead is also borne by the clients. As such, the number of users of TURN services are few.

Other proprietary NAT traversal techniques can be employed, but these are typically designed to work with only a defined type of traffic (such as universal datagram packet (UDP) traffic) and have difficulties in allowing the NAT traversal for other traffic types (such as transmission control protocol (TCP) traffic).

Therefore, it would be desirable to provide a system and method that obviate or mitigate the above described problems

### SUMMARY

It is an object of the present invention to obviate or mitigate at least one disadvantage of the prior art.

In a first aspect of the present invention, there is provided a method of facilitating communication between two nodes in a communication network. The method comprises the steps of receiving, over a first network interface, a first packet having a header and intended for delivery to the second node, from a first of the two communication nodes; receiving, over a second network interface, a first packet having a header and intended for delivery to the first node, from a second of the two communication nodes; and generating a header for a packet intended for the first node in accordance with the header of the first packet from the first communication node, and the header of the first packet from the second communication node.

In an embodiment of the first aspect of the present invention, the method further includes a step of generating a header for a packet for the second node in accordance with the header of the first packet from the first communication node and the header of the first packet from the second communication node, and can optionally include the step of transmitting packets having the generated headers to the first and second nodes.

In another embodiment of the first aspect of the present invention, the step of receiving the first packet the first communication nodes includes receiving a packet from the first communication node, and determining that the packet has a SYN flag set. In a further embodiment, the steps of receiving the first packet from each of the first communication node and the second communication node includes storing the received headers. In a further embodiment, the step of generating a header includes setting a SYN ACK flag and optionally, the step of setting a SYN ACK flag is performed in response to detection of a SYN flag in the header of the packet received from the first communication node. In a further embodiment, the step of generating a header includes setting a sequence number in the generated header in accordance with a sequence number in the header of the first packet received from the second communication node. In another embodiment, the step of generating a header includes setting a sequence acknowledgement number in the generated header in accordance with a sequence number in the header of the first packet received from the first communication node. In an alternate embodiment, the step of generating a header includes generating checksum values in accordance with the generated header values and a packet payload. In a further embodiment, the step of generating a header includes setting a destination port value in accordance with a source port value in the header of the first packet received from the first communication node, and optionally, further includes setting a source port value in accordance with a preconfigured source port value. In a further embodiment, the method includes, prior to the step of receiving the first packet from the first node, the step of transmitting, to the first node, an invitation to join a session, the invitation specifying a network address associated with the first network interface, and optionally prior to the step of receiving the first packet from the second node, the step of transmitting, to the second node, an invitation to join the session, the invitation specifying a network address associated with the second network interface. In further embodiments, the step of transmitting the invitation to the second node is performed in response to receiving the first packet from the first node. In other embodiments the steps of transmitting invitations to the first and second nodes are performed by requesting that a third party issue the invitations to the first and second nodes.

In a second aspect of the present invention, there is provided a peer-to-peer traffic switch for switching packets between a first node and a second node. Tthe packet switch comprises a network interface, a buffer and a packet switch re-assembler. The network interface receives packets from, and transmits packets to, the first and second nodes. The buffer stores header information associated with packets received from the first and second nodes over the network interface. The packet switch re-assembler generates a header associated with a packet destined for the first node in accordance with header information associated with packets received from the first and second nodes over the network interface, the generated header having a SYN ACK flag value set in accordance with a SYN flag value from with a stored header associated with a packet received from the first node over the network interface, and transmits the generated header, along with the associated packet to the first node through the network interface.

In an embodiment of the second aspect of the present invention, the peer-to-peer traffic switch further includes a checksum calculator for generating a checksum to be stored in the generated header in accordance with the generated header and the associated packet in response to a request received from the packet switch header. In another embodiment, the network interface includes a first port for receiving packets from, and transmitting packets to, the first node; and a second port for receiving packets from, and transmitting packets to, the second node. In a further embodiment, the buffer includes a first memory for storing header information associated with packets from the first node; and a second memory for storing header information associated with packets from the second node.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 is a flowchart illustrating a method of initializing a packet switching session;

FIG. 2 is a flowchart illustrating a method of switching the first packets received in a packet switching session;

FIG. 3 is a flowchart illustrating a method of initializing a packet switching session;

FIG. 4 is a block diagram illustrating the network layers/packet header of a packet received from a first node in a switching session;

FIG. 5 is a block diagram illustrating the network layers/packet header of a packet received from a second node in a switching session;

FIG. 6 is a block diagram illustrating the network layers/packet header of a packet destined to a first node in a switching session;

FIG. 7 is a block diagram illustrating the network layers/packet header of a packet destined to a second node in a switching session;

FIG. 8 is a flowchart illustrating a method of generating a header for a switched packet;

FIG. 9 is a flowchart illustrating a method of generating a header for a switched packet; and

FIG. 10 is a block diagram illustrating the logical configuration of a system of the present invention.

### DETAILED DESCRIPTION

The present invention is directed to a system and method for switching packets across gateways.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

In the following discussion a method and system are described that allow for communication between two peers through a peer-to-peer traffic switching node. In the discussions presented below, each of the peers and the traffic switching node will be shown as residing behind a Network Address Translation Gateway. This is not intended to be limiting in scope, as the systems and methods can just as easily be implemented with any or all of the nodes having publicly accessible addresses. Furthermore, although the gateways discussed below are NAT gateways, it should be not be misinterpreted as being limited, and those skilled in the art will appreciate that any of the nodes can exist behind another gateway (such as one directed at bridging IPv4 networks to IPv6 networks.

If node A and node B each reside in different private networks connected to the public internet through gateways, there are many known problems in creating a peer-to-peer connection between them. To address this, the request to initiate a session is performed through a third party. The third party allows a user associated with node A to select a user associated with node B using an identifier other than the IP address associated with node B. The mechanism for node A to contact the third party server can vary, but in this non-limiting example the third party is associated with a service provider, such as a network access provider or a network service provider. The third party may be in a private network, but as a server that is relied upon it can be assigned a specified port by its NAT gateway. This allows the plurality of connected devices, such as nodes A and B, to be able to contact it at a fixed address. The fixed address may be specified as a domain name that is then resolved to an IP address that is variable. The resolution of the domain name to the IP address can also provide requesting nodes the port through which the third party server is reached.

If a request for a session initialization is made by node A, it will specify that the intended destination is a user associated with node B. The server can then determine that the requested user is logged in on node B. One skilled in the art will appreciate that details related to how a user specifies the intended session destination can vary without departing from the intended scope of the present invention.

The third party server can then issue a request to a new network element, hereinafter referred to as a peer-to-peer traffic switch (P2PTS), to create a session between two specified nodes. The P2PTS allocates resources, including a public address that is provided to each node, to which traffic is to be directed. This address information is separately provided to each of nodes A and B, preferably through the third party server. When the P2PTS receives data packets from a first one of the nodes, it can switch the traffic and direct it to the other node. To avoid problems, the P2PTS will modify the header information associated with received packets before sending the packet to the destination. The modification of the received packet header allows each of the nodes to confirm acknowledgements where appropriate. This setup allows Node A to be provided an address associated with the P2PTS that is can effectively treat as the address for Node B during the session (and vice versa). The payload of the packets relayed between Node A and Node B need not be inspected or even considered. As only header information needs to be altered only a very small buffer is required at the P2PTS to ensure that the traffic is switched between the nodes transparently. Such an implementation allows optimization of the traffic handling to reduce the overhead resources required by the P2PTS. Nodes A and B can be provided with a single address for the session, which would require the P2PTS to determine the sender of a packet so that the destination can be determined. Alternatively, Nodes A and B can be provided different addresses, so that two addresses will be reserved for each session. In doing this, Node A is provided an address that it will send packets to, and Node B will be provided a different address that it will send packets to. The destination of a packet received at the P2PTS can then be determined solely by the address that the packet is received over. One skilled in the art will appreciate that the use of the term “address” need not be limited to the IP address, but may include both the IP Address and a identification of a port.

When P2PTS makes use of multiple ports on a single address, it is able to serve a large number of sessions based on a single address. This can also allow for the P2PTS to be behind a gateway such as a NAT gateway. The address provided to a node in a session would simply be the IP address of the NAT gateway along with a port. The NAT gateway would preferably be configured to allow all traffic from a block of ports to be routed to the P2PTS. This block of ports at the NAT that forwards directly to the P2PTS would form the block of available resources for the P2PTS.

Some of the mechanics of how to initialize a session will now be discussed with respect to the Figures.

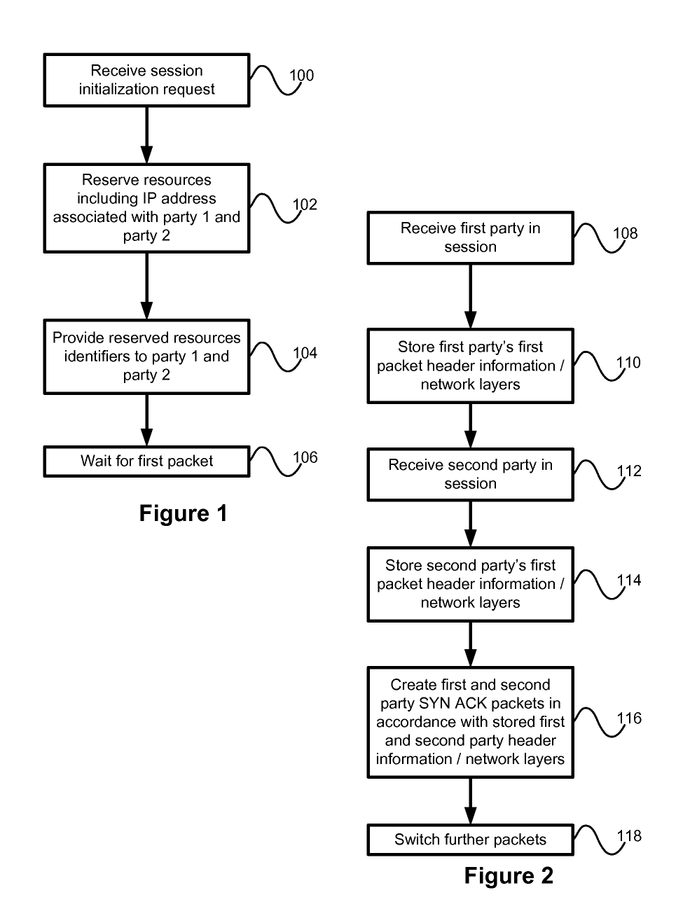

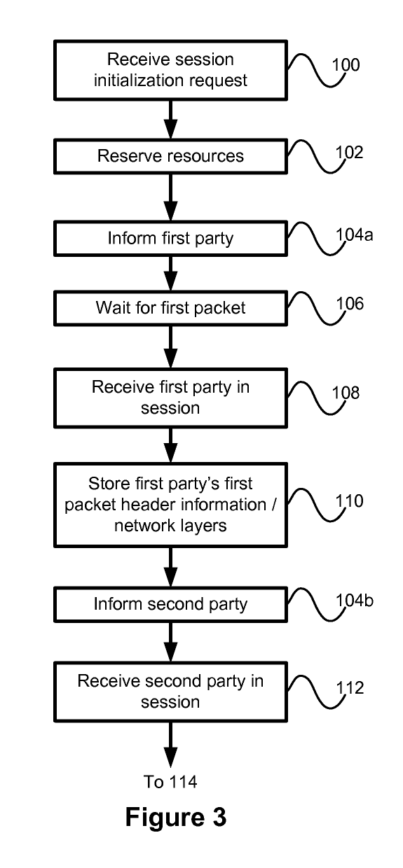

FIG. 1 illustrates an exemplary embodiment, that starts in step 100 with the P2PTS receiving a session initialization request. This request originates with one of the users, but may be received through an intermediate such as a communication server. Upon receiving a session initialization request the P2PTS reserves resources required for the requested session in step 102. These resources may include at least one address (which may also include a port associated with the address). Identification of the reserved resources is provided to the peer-to-peer nodes in step 104. Providing the identification can includes transmitting identification of the resources directly to each of the nodes (either in parallel or in series), or this notification can be provided to the third party communication server for delivery to the nodes. Upon providing of the identification of the resources, the P2PTS waits for the start of the session in step 106.

As noted above, the resources reserved in step 102 include an address that will be provided to node A through which it can transfer content to node B, and an address that will be provided to node B through which it can transfer content to node A. Each address can include both an IP address and an assigned port, and while in some implementations both node A and node B can be provided the same address (with traffic switched based on an identification of the sending address) it is also possible for each node to be provided unique IP address and port pairing, in which case all traffic received on a particular port is forwarded to a set destination. As ports can be used, such a method can be implemented by a P2PTS behind a NAT gateway.

FIG. 2 illustrates an exemplary embodiment of a method carried out by the P2PTS after the session preparation have been carried out. In step 108 a first active party is received. The first active party is the node that first connects to the P2PTS, and this can be determined by examining the address that the connection has been made through and determining if the corresponding peer has joined. In step 110, the header information, or network layers, of the first active party's first packet is saved. Typically this can be done by copying the header information into a buffer allocated as a resource to the session. The payload can be discarded at this point. In step 112, the second active party is received into the session, and its first packet header information/network layers are stored in step 114. In step 116, first and second party SYN ACK packets are created in accordance with the stored 1^{st} and 2^{nd} party header information/network layers. When a party connects to the P2PTS, it includes TCP information that it expects to receive in the acknowledgement reply. This information is found in the header to the first received packet. Each of the two parties initiates a connection with the P2PTS, and thus each party provides its own SYN frame information. In a conventional peer-to-peer connection, one node or another would initiate the connection, and the other node would use the SYN frame information selected by the initiating node. However, to bypass a NAT gateway, both of the peer nodes are asked to initiate a session with the P2PTS. This results in the P2PTS needing to reply to each using the SYN ACK frame based on the information that it received in the headers. This information can also be used to perform lightweight modification of the subsequent headers during step 118 as further packets are switched.

When the user of Node A requests a peer-to-peer session with the user of Node B, it can be assumed that the user of Node A will be a part of the session. However, the user of node B can decline to participate. Accordingly, when the P2PTS notifies both parties of the resources, it can provide the invitation to the user of Node B first (knowing that the user of Node A will accept the invitation), and upon receiving the user of Node B, can then issue an invitation to the user of Node A to join the session. Thus, from the perspective of the P2PTS, the user that requests the session is typically the second party in a communication session, as the invitee is typically provided the invitation (which indicates the reserved resources first).

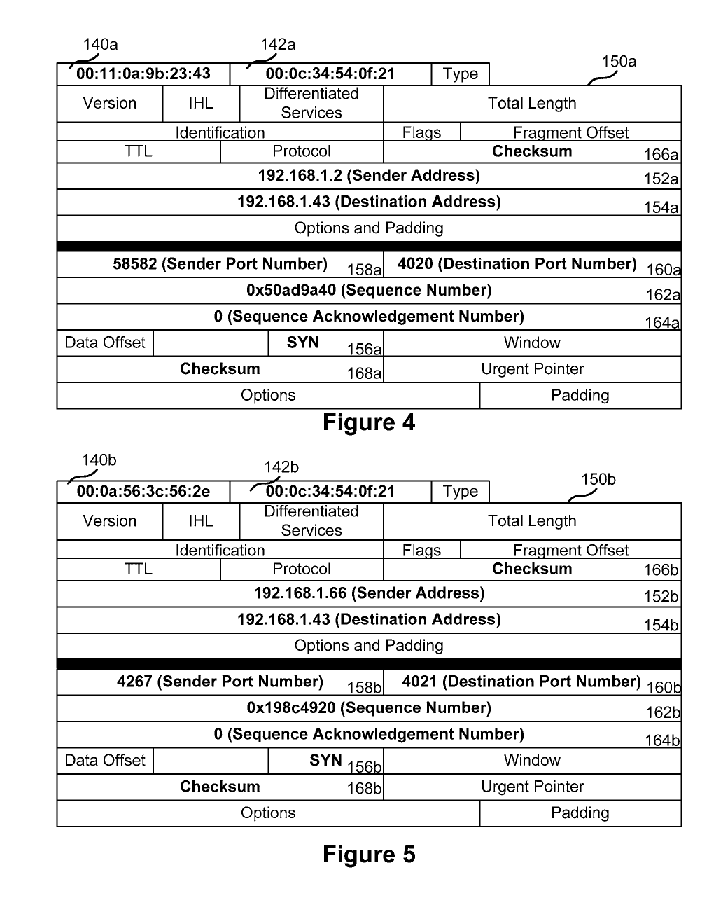

When either of the parties joins a session, the joining party typically issues a packet with the SYN flag set as on. Information obtained from this packet is stored in the P2PTS buffers allocated to the session. When both parties have joined the session, there are two such sets of information. FIGS. 4 and 5 illustrate the headers of packets received from nodes A and B respectively. Packet header 150a in FIG. 4 is representative of the combination of the IP packet header and TCP packet header of a packet received from node A (having an IP address of 192.168.1.2) by the P2PTS (having an IP address of 192.168.1.43). A sender address field 152a identifies the origin of the packet, while a destination address field 154a identifies the destination of the packet, which is representative of the P2PTS. In the IP flags section 156a of the header, the packet is indicated to be SYN packet. In field 158a, a source port is identified, while in filed 160a a destination port is identified. The sequence number is provided in field 162a, and as this is the first packet send in a communication no acknowledgement is provided in field 164a. The IP checksum 166a and TCP checksum 168a are also shown here. These values need not be preserved from the initial receipt, as they are programmatically generated, and may need to be regenerated as will be indicated below. In addition to this TCP/IP header information, the received communication from Node A includes the MAC address of the sender 140a and the receiver 142a.

In FIG. 5, packet header 15b is representative of the combination of the IP packet header and TCP packet header of a packet received from node B (having an IP address of 192.168.1.66) by the P2PTS (having an IP address of 192.168.1.43). As with FIG. 4, the source and destination addresses are provided in fields 152b and 154b respectively, while filed 156b indicates that this is a SYN packet. Fields 158b, 160b, 162b and 164b provide the source port, the destination port, the sequence number and the sequence acknowledgement number respectively. Additionally illustrated are the MAC address of the sender 140b, and the MAC address of the receiver 142b, along with the IP checksum 166b and TCP checksum 168b. As noted above, although the sender MAC address 140b may be relevant to store, the other values are either known to the P2PTS or can (or should) be recalculated later.

As one can see, when connecting nodes A and B, P2PTS is in the situation of having each of these two nodes believing that it initiated the connection. As a result, each of nodes A and B have requested SYN acknowledgement, and have set a sequence number that is to form the basis of numbering packets exchanged between the two of them. To provide a seamless experience, and to allow the peer nodes to operate as if there is an unswitched connection between them, the P2PTS will reply to each node on behalf of the other. This reply will contain header information that is synthesized based on the material in each of the received headers. As the traffic switching continues, packet headers can be modified to allow for replacement of the sequence number so that each node receives responses that it expects. One skilled in the art will appreciate that such modifications can be performed without examining the payload of the packet, and as such can be performed without incurring a large processor overhead in the P2PTS.

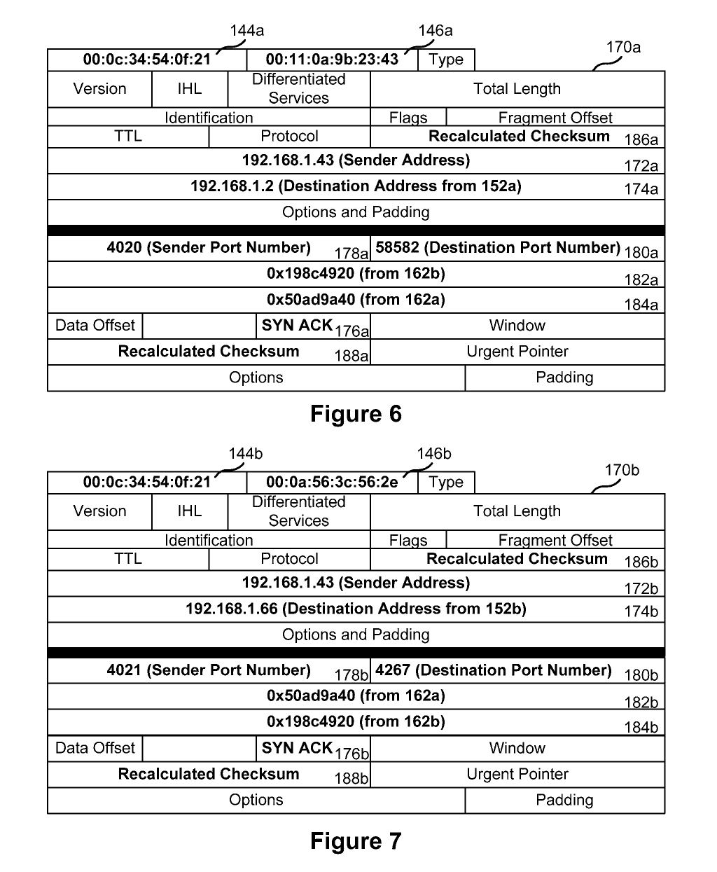

FIG. 6 illustrates header or network layer information associated with a SYN-ACK TCP/IP frame 170a that is sent back to Node A. Thus, it is effectively a response to the packet that accompanied the header shown in FIG. 4. The MAC address of the sender 144a and the receiver 146a are the opposite of what they were in FIG. 4. The source address field 172a now indicates the address associated with P2PTS, while the destination address field 174a now indicates the address associated with Node A. As it is a response to the SYN frame of FIG. 5, it is indicated as a SYN ACK by field 176a. The source port field 178a and destination port field 180a are inverted to accord with the inversion of the addresses in fields 172a and 174a. The sequence number field 182a contains the sequence value 160b provided by Node B in frame 150b, while the sequence acknowledgement field 184a contains the sequence value 160a provided by Node A in frame 150a. The IP checksum value 186a provided with this packet has been recomputed so that it does not indicate that the packet has been modified. Furthermore, the TCP checksum 188a can also be recalculated if necessary, or if no modification has been performed that would have altered the TCP checksum, and the checksum value had been stored, the value received in 168b could be re-used.

FIG. 7 illustrates header or network layer information associated with a SYN-ACK TCP/IP frame 170b that is sent back to Node B. The MAC address of the sender 144b and receiver 146b are in the inverted order as they would have been shown in FIG. 5. The source and destination addresses 172b and 174b and the source and destination ports 178b and 180b are reversed from the order provided in frame 150b to indicate that the packet is routed from P2PTS to Node B. The SYN-ACK flag is set in field 176b. The sequence number in field 182b is taken from field 162a in frame 150a, and the sequence acknowledgement number in field 184b is taken from field 162b in frame 150b. As with frame 160a, the IP checksum 186b of this frame can be recalculated to ensure that there are no errors that may cause re-connection problems. The TCP checksum 188b can also be recalculated, or the value from 168a can be re-used if no modifications have been performed that would invalidate the checksum and if the previous value had been stored.

As noted above, when considered together FIGS. 4-7 illustrate that the creating SYN ACK packets in accordance with the stored values from the packets received from nodes A and B, described in conjunction with step 116 can be performed in accordance with the information received from each of nodes A and B. When this is performed, neither of nodes A and B becomes aware that it is connecting to an intermediary. A requirement to computer checksums and select values in a header based on already stored values can be handled without great impact on many infrastructure grade nodes in a network, especially those run by a service provider.

Those skilled in the art will appreciate that after the creation of a SYN ACK, the P2PTS can simply adjust the IP addresses, the port numbers, and sequence and acknowledgement numbers of outgoing packets in accordance with corresponding values of incoming packets. Checksums for outgoing packets can be computed prior to transmission using standard techniques. The buffering of these values can be done without necessarily having to store the full packet. Instead, only some of the information associated with the packet is needed. Although in some embodiments, a buffer can be created to store either the full TCP/IP packet, or just the TCP/IP header, other implementations can make use of a buffer that only stores the values needed to create the header values that will allow either of Nodes A or B to receive packets without determining that an error has occurred.

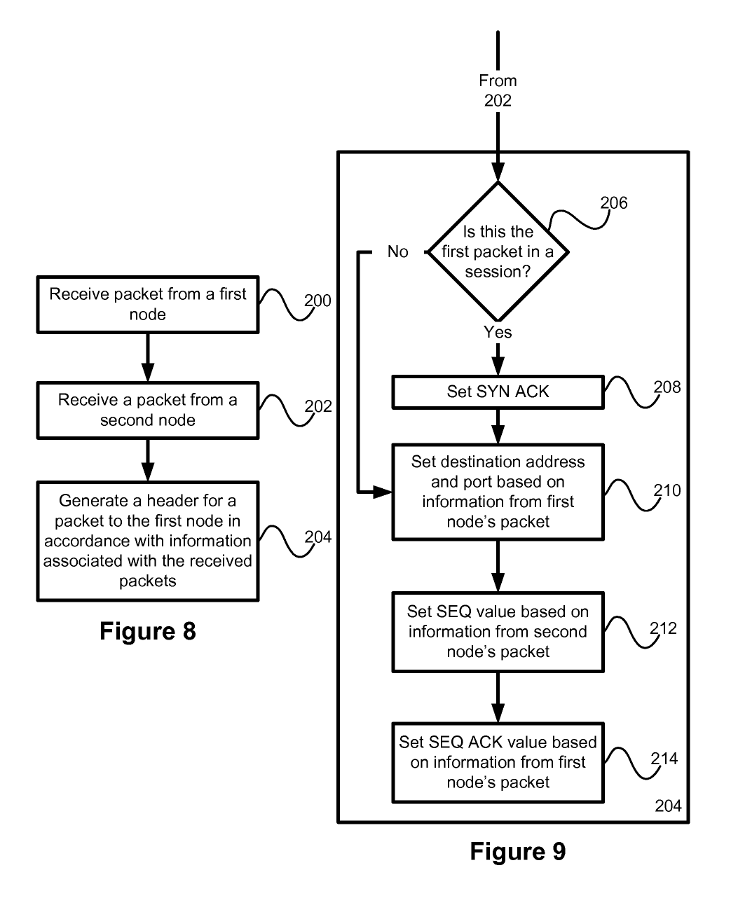

FIG. 8 illustrates a method of operation at the P2PTS which upon receiving packets from a first node in step 200 and a second node in step 202, generates a header for a packet for transmission to the first node in step 204. The generation of the header is done in accordance with information associated with the packets received from the first and second nodes.

FIG. 9 illustrates an exemplary embodiment of step 204 in FIG. 8. After completion of step 202, the P2PTS determines if the received packet from the first node is the first packet in the session in step 206. If it is the first packet in the session (which can be determined in a number of ways including examining the packet received in step 200 to determine if a SYN flag has been set), the method proceeds to step 208 where a SYN ACK flag is set. Step 208 is skipped if the determination in step 206 is negative, and the method for both paths proceeds to step 210 where the destination address and port for the packet being sent to the first node are set based on information associated with the first packet. The source destination and address are typically set to values associated with the P2PTS, and while related to the session, need not be related to any received packets. Following the setting of the destination values, a Sequence value is set in step 212 based on information associated with the packet received from the second node in step 202. The Sequence Acknowledgement can then be set in step 214 to a value associated with the packet received from the first node in step 200.

One skilled in the art will appreciate that the methods described in FIGS. 8 and 9 work for a bi-directional data flow as each of nodes A and B could be the first and second nodes. Additionally, the order of steps 200 and 202 is not essential; they can be performed in series or in parallel with each other. Steps 208-214 need not be performed in any particular order. These steps can be combined with each other, performed in series or in parallel as needed, and can be supplemented with other steps without departing from the intended scope of the method. When Node A first communicates with P2PTS, its first packet is preferably buffered until the first packet is received from Node B. Each of the first packets can then be subjected to the method illustrated in FIG. 9.

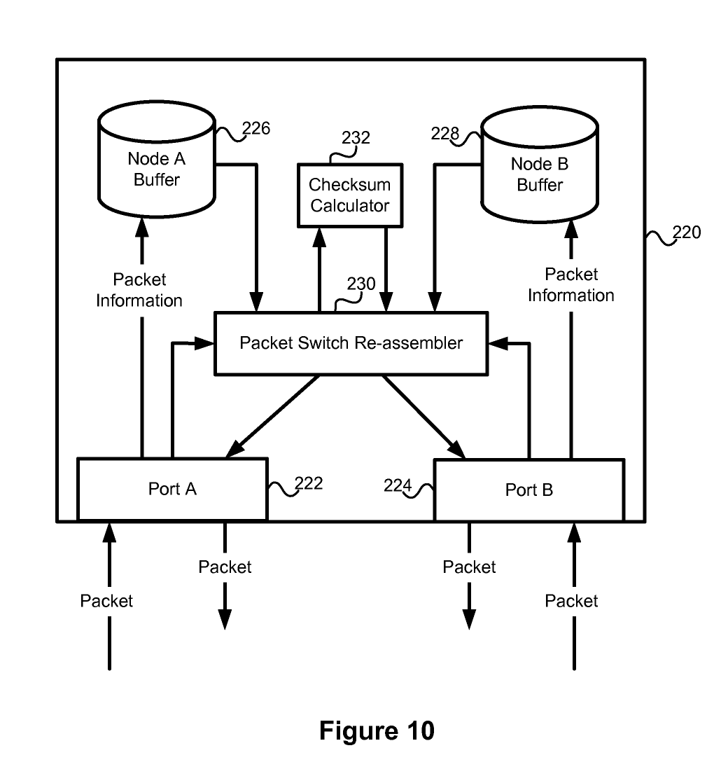

FIG. 10 is a block diagram illustrating a functional implementation of a P2PTS 220. One skilled in the art will appreciate that the functional elements illustrated in FIG. 10 can be implemented in combinations of dedicated hardware, general purpose processors executing sets of instructions, and other assorted implementations. The P2PTS 220 includes a network interface for communicating with node A, illustrated here as a port A 222. Port A 222 receives packets and stores packet information in a buffer 226 allocated to the communication session. Similarly, Port B 224 is used for communicating with node B, and stores packet information in buffer 228. A packet switch re-assembler uses the packet information in buffers 226 and 228 to generate packet header information that can replace the headers on packets received from Port A 222 or Port B 224. Where a checksum is included in the header, packet switch re-assembler 230 can make use of a checksum calculator 232 to generate a checksum for the generated packet header. The payload of a received packet is combined with the generated header to create a reassembled packet in the packet switch reassembler 230, and forwarded to the port corresponding to the reassembled packet destination (Port B 224 for packets received on Port A 222, and vice versa) from which it is transmitted to its destination.

One skilled in the art will appreciate that in implementation, the buffers 226 and 228 can be logically separated from each other but remain in the same memory system, and that port A 222 and Port B 224 can be logical constructs that make use of the same physically network interface. Additionally, as noted above, these two ports need not be unique, in which case, packet switch re-assembler can determine the destination address based on the packet information of the received packet, which would identify the sender. The checksum calculator could be implemented in a general purpose processor, which could be the same general purpose processor used to implement the packet switch re-assembler. Alternatively dedicated hardware could be employed to take advantage of the specialized nature of some processors to compute values such as checksums.

One skilled in the art will appreciate that the above described system and method modify header information in packets received from both Node A and Node B. Whereas previous attempts at packet switching in such environments rely upon both nodes communicating with a switching entity, in such setups both nodes are aware that they are communicating with such an entity. However, in the currently provided solution, Node A can behave as if the address provided for communication with the P2PTS is the address of Node B. Similarly, Node B can operate as if the address of P2PTS is the address of Node A. As the invitations can be issued by the communication server, the process can be as simple, as Node B requesting a session with Node A, Node A receiving a session initiation invitation and responding to it by sending a first packet to the address it associates with Node B (the address of the P2PTS), upon seeing that Node A has joined the session, the P2PTS can then ask that Node B be invited to join the session. After Node B joins the session the headers associated with the first packets can be established, and both parties will be able to send and receive data. The header information of packets received from the switch will appear to be correct in the perspective of either Node A or Node B.

As only the header information is modified, the process can be implemented on either general purpose, or specialized, hardware. Additionally, it will be understood that any security methods that do not encrypt the header (e.g. TLS or SSL) can make use of the method and system described herein. A negotiated encryption can be done without the P2PTS partaking in the negotiation, and as a result communication between Node A and Node B will still be secure. Secure transmission methods that employ encryption of the header can still be supported if the P2PTS is able to decrypt, and re-set the relevant header fields.

Embodiments of the invention may be represented as a software product stored in a machine-readable medium (also referred to as a computer-readable medium, a processor-readable medium, or a computer usable medium having a computer readable program code embodied therein). The machine-readable medium may be any suitable tangible medium including a magnetic, optical, or electrical storage medium including a diskette, compact disk read only memory (CD-ROM), digital versatile disc read only memory (DVD-ROM) memory device (volatile or non-volatile), or similar storage mechanism. The machine-readable medium may contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention may also be stored on the machine-readable medium. Software running from the machine-readable medium may interface with circuitry to perform the described tasks.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method of facilitating communication between two nodes in a communication network, the method comprising:
receiving, over a first network interface, a first packet having a header and intended for delivery to the second node, from a first of the two communication nodes;
receiving, over a second network interface, a first packet having a header and intended for delivery to the first node, from a second of the two communication nodes; and
generating a header for a packet intended for the first node in accordance with the header of the first packet from the first communication node, and the header of the first packet from the second communication node.

2. The method of claim 1, further including generating a header for a packet for the second node in accordance with the header of the first packet from the first communication node and the header of the first packet from the second communication node.

3. The method of claim 2 further including the step of transmitting packets having the generated headers to the first and second nodes.

4. The method of claim 1 wherein the step of receiving the first packet the first communication nodes includes receiving a packet from the first communication node, and determining that the packet has a SYN flag set.

5. The method of claim 1, wherein the steps of receiving the first packet from each of the first communication node and the second communication node includes storing the received headers.

6. The method of claim 1, wherein the step of generating a header includes setting a SYN ACK flag.

7. The method of claim 6 wherein the step of setting a SYN ACK flag is performed in response to detection of a SYN flag in the header of the packet received from the first communication node.

8. The method of claim 1, wherein the step of generating a header includes setting a sequence number in the generated header in accordance with a sequence number in the header of the first packet received from the second communication node.

9. The method of claim 1, wherein the step of generating a header includes setting a sequence acknowledgement number in the generated header in accordance with a sequence number in the header of the first packet received from the first communication node.

10. The method of claim 1, wherein the step of generating a header includes generating checksum values in accordance with the generated header values and a packet payload.

11. The method of claim 1, wherein the step of generating a header includes setting a destination port value in accordance with a source port value in the header of the first packet received from the first communication node.

12. The method of claim 11 wherein the step of generating a header further includes setting a source port value in accordance with a preconfigured source port value.

13. The method of claim 1 further including, prior to the step of receiving the first packet from the first node, the step of transmitting, to the first node, an invitation to join a session, the invitation specifying a network address associated with the first network interface.

14. The method of claim 13, further including, prior to the step of receiving the first packet from the second node, the step of transmitting, to the second node, an invitation to join the session, the invitation specifying a network address associated with the second network interface.

15. The method of claim 14 wherein the step of transmitting the invitation to the second node is performed in response to receiving the first packet from the first node.

16. The method of claim 14 wherein the steps of transmitting invitations to the first and second nodes are performed by requesting that a third party issue the invitations to the first and second nodes.

17. A peer-to-peer traffic switch for switching packets between a first node and a second node, the packet switch comprising:
a network interface for receiving packets from, and transmitting packets to, the first and second nodes;
a buffer for storing header information associated with packets received from the first and second nodes over the network interface; and
a packet switch re-assembler for generating a header associated with a packet destined for the first node in accordance with header information associated with packets received from the first and second nodes over the network interface, the generated header having a SYN ACK flag value set in accordance with a SYN flag value from with a stored header associated with a packet received from the first node over the network interface, and for transmitting the generated header, along with the associated packet to the first node through the network interface.

18. The switch of claim 17 further including a checksum calculator for generating a checksum to be stored in the generated header in accordance with the generated header and the associated packet in response to a request received from the packet switch header.

19. The switch of claim 17 wherein the network interface includes:
a first port for receiving packets from, and transmitting packets to, the first node; and
a second port for receiving packets from, and transmitting packets to, the second node.

20. The switch of claim 17 wherein the buffer includes:
a first memory for storing header information associated with packets from the first node; and
a second memory for storing header information associated with packets from the second node.
